(19) United States
(12) Patent Application Publication
(10) Pub. No.: US 2011/0122103 A1
(43) Pub. Date: May 26, 2011

(54) DEVICE WITH A LABEL

(76) Inventor: Beat De Coi, Sargans (CH)

(21) Appl. No.: 12/936,132

(22) PCT Filed: Apr. 3, 2009
(86) PCT No.: PCT/EP2009/002451

§ 371 Date: Dec. 20, 2010

(30) Foreign Application Priority Data
Apr. 3, 2008 (DE) 10 2008 017 531.5

(51) Int. Cl. G09G 5/00

(52) U.S. Cl. 345/204

(57) ABSTRACT

A device with a label is proposed wherein image information, in particular information about the device, is provided in the label. The label includes a display unit with a display area. Electronic image information can be written in the display area in a manner visible for a user, wherein the written image information will remain on the display area even when the display unit is in a powerless state. The image information in the display area can be replaced by other image information by electronic means. A control unit is provided for electronic writing and/or replacement of image information in the display area. Furthermore, at least one status feature regarding the control unit's own mode of operation and/or information which reflects this mode of operation can be displayed in the display area.

### STATE OF THE ART

Products and devices which are provided with their final characteristic feature and function determining the concrete applicability only after the final programming subsequent to the production are known.

Different configurations and adaptations of the characteristic feature are obtained, for instance, with a corresponding software. It is, for instance, possible that optically identical devices and products exhibit different operating modes and are operated differently, respectively, as a result of the respectively performed configuration. In order to find out the final configuration of such a product corresponding product identifications and labels are provided.

With products that can have a plurality of configurations it is impracticable and relatively complicated to provide a different identification for all possible final configurations.

The consequence thereof may be that products are provided with a label only after they have been sold, or even that a unique identification is waived.

If necessary, a person carries out an identification manually.

Therefore, the procedure used so far is not satisfactory and involves a high error rate.

### OBJECT AND ADVANTAGES OF THE INVENTION

It is the object of the present invention to identify generic devices in an economically and technically advantageous manner.

This object is achieved by the independent claims. Advantageous embodiments of the invention are defined in the dependent claims.

The invention is based on a device comprising a label for the device, wherein image information, in particular information about the device are provided in the label. The label comprises a display unit with a display area, in which image information can be written electronically into the display area in a manner visible to a user, wherein the written image information remain on the display area even if the display unit is in a currentless state, and wherein the image information in the display area are electronically replaceable by other image information. The device further comprises a control unit for controlling the device. The gist of the invention resides in that the control unit for controlling the device is also provided to electronically write in and/or replace image information in the display area, and that the control unit is adapted to display in the display area at least one status feature of the own mode of operation and/or an information reflecting this mode of operation, in particular how a user can use the device based on this mode of operation.

Preferably, the label is firmly connected to the control unit. The procedure according to the invention allows a user to easily recognize in a simple manner how the control unit of an electrical device works and is configured also in terms of the external effect. This substantially facilitates the use of the device and a possible maintenance.

A label particularly refers to an area formed on the device which is designed to contain readable data about the device that characterize the mode of operation. These data can be acquired by a person and/or a reading device. The device may be any electronic device having a control unit, whose mode of operation can be displayed, particularly as image information. Specifically, the device may comprise a sensor, particularly an optical sensor having a transmitter and/or receiver of different type, e.g. a distance sensor, a TOF sensor (time-of-flight sensor) for a time-of-flight measurement, or a pulse-time delay sensor. Moreover, the device may be a laser scanner, a scan curtain, a camera or the like.

Preferably, the label is written in a factory after the production of the device. Preferably, this process is performed after the control unit was programmed. For writing the label the device itself or an external additional device may be used.

In the context of the term mode of operation of a device also phrasings like configuration and/or behavior of a device are utilized so as to emphasize the understanding regarding the type of the mode of operation more distinctly. In concrete terms a mode of operation can imply, for instance, a software version running on the control unit. In this context, for instance, also the term “configuration” is used.

Preferably, mode of operation aims at the activated state of the device and the control unit. Advantageously, a mode of operation of the controller is concerned, which predetermines how a user can use the device in terms of an externally recognizable effect and/or which functions are available to a user. Specifically, an operating mode of the control unit as an internal feature is concerned, which determines the external use and fields of application of the device by a user, however.

In case of an optical sensor the control unit is, for instance, operated such that only every second transmitter and receiver of an assembly of transmitters and receivers is available in an operating mode, either because only every second pair of transmitters and receivers is driven or because only every second site in a housing is occupied with pairs of transmitters and receivers in the present configuration of the device. Preferably, this configuration of the controller is made available to a user directly by means of an image information, and/or in form of an indirect information to the effect that the device's behavior based thereon is displayed.

In a preferred embodiment of the invention the control unit is adapted, when the at least one status feature of the own mode of operation is changed, to update written image information with respect to the change made to the mode of operation and display them as currently valid image information.

By means of this measure it is ensured that each operating mode of the control unit, which was predefined as being important, is reproduced on the display also in an externally visible manner, above all if another intervention to the device was made, e.g. a software change, after the finalization of the device. Preferably, the display is updated fully automatically without requiring an intervention by an operator.

If a device or apparatus can be operated in several different modes, the current mode is preferably displayable by the image information.

Advantageously, the full function of the display unit is maintained even if it not supplied with energy or current, respectively. The device on which the label is provided may be independent of the power supply of the display unit, e.g. by means of an own power supply. It is possible that the power supply of the display unit be switched to and cut off from, or disconnected from and connected to the power supply of the device, respectively.

The mode of operation of the device may also be controlled, for instance, by a processing unit or processor, respectively, specifically a computer, e.g. a portable small computer. The processing unit or processor, respectively, can control the control unit, or the processing unit or processor, respectively, can form the control unit itself.

Image information refer to any contents displayable in the display area. For displaying the information, for instance, letter symbols, number symbols, display symbols or images may be used. However, the image information may also comprise patterns or structures so as to realize, for instance, a design effect on the object or a desired appearance of the object.

The image information need not necessarily be written into the display area in a direct electronic way, but this may also be accomplished by indirect processes or in a physical manner, respectively. For instance, image information may be written by using the effect of light or by means of an electronically controlled laser or another, e.g. chemical or biological process by means of which electronically available data can be displayed in the display area.

As an essential element of the label, for instance, an electronic paper may be used, e.g. on the basis of smart paper technology as is known, for instance, under the names of “Gyricon” or “eInk”.

According to the invention a label may be provided as a display or non-volatile display, respectively, which has to be supplied with electric power merely for writing in image information, while a display is permanently readable afterwards even without a power supply.

Beside the inventive display area it is basically not precluded that also other areas are provided on the label, which serve to display image information, especially information about the device, e.g. areas designed in a known manner.

Another essential aspect of the invention resides in that the control unit is designed in such a way that, by an intended change of the image information to a currently valid image information, the mode of operation of the control unit is changed in accordance with the currently valid image information. A great reliability is thus achieved in view of the characterization of the device, to the effect that the displayed image information on the label corresponds to the actually prevailing mode of operation of the devices. An external change of the image information has, for instance, the consequence that the device, especially after the next activation, exhibits a different behavior or different mode of operation, respectively.

Moreover, a possible action meant to change the function of the device is easier to accomplish because the change that has been made can be checked directly from outside in a clearly visible manner or can be seen by means of the image information displayed in the display area. Also, it may be easier, if applicable, to change the characteristic feature of the device by means of the label provided specifically on the outside of the device. Otherwise, an influence exerted by a unit inside the device would be necessary, e.g. an intelligent unit or processing unit, respectively, e.g. the control unit, which might necessitate additional components, connections or lines.

Advantageously, the label is provided on an outer side of the device. Thus, the label permits a user to read and register, if applicable also in an automated manner or by means of a reading device, respectively, externally visible features indicative of the mode of operation of the device, a device type, a sales price or other image information and device data in a fast and simple manner. The label can, for instance, be integrated in, permanently affixed to and/or detachably provided on an outer side of the housing. The label may be designed flat, thin and flexible, e.g. when using an electronic paper, and can therefore be used like known labels with respect to its attachment. For the purpose of protection the label may particularly be provided with a transparent, thin cover, e.g. of a film type. An outer side of the label may be flat and plane, respectively, and particularly not or slightly projecting over or flush with the outer side of the object.

Advantageously, the display unit is formed on housing means which surround the interior of the device. Products to be labeled frequently comprise a housing, especially if components to be protected and sensitive electronic and/or optical components, respectively, are provided in the interior of the object. This may be the case, for instance, if electronic equipment are involved, or assemblies whose interior has to be protected against pollution, moisture, temperature, shocks or radiation. In this case it is an advantage if the label or at least the display unit or the display area of the label are provided on a portion of the housing in a manner visible from outside.

As an interference can never be fully precluded despite measures to shield the display area against internal and external interference fields and external electric fields, respectively, which interfere with and negatively influence the image information displayed in the display area, it is an advantage that, after an interference with lasting incorrect data in the display area, the control unit displays and writes in anew the previously displayed image information. Where applicable, this may be effected in an automated manner at predetermined time intervals, which increases the display reliability. In this case it is unproblematic if a new display in the display area takes place even though no interference has to be removed because the present image information is then merely identically overwritten.

The electric supply of the control unit, e.g. for writing in image information, may be accomplished by batteries or a power supply provided by a supply mains. As writing in image information requires electric current only from time to time, as a rule proportionally only very short phases, the power supply can advantageously be readily accomplished by a current storage means, e.g. a battery or capacitor, respectively.

Advantageously, the control unit is adapted to acquire the appropriate image information of the respective device and write them into the display area. Depending on the configuration of the device from a plurality of possible configurations this configuration can be recognized by the control unit itself and be written into the display area. Thus, a present configuration can be displayed in the display area automatically, directly and always in an up-to-date manner.

Furthermore, it is preferred that the control unit is adapted to write additional information provided in addition to image information about the control unit of the device into the display area in an electronic manner. This permits an advantageous realization of an interface to a user, by means of which image information and acknowledgments, respectively, are provided to a user when he is using the device. For instance, warnings, error messages, a previous history and a price of the device, respectively, or a statistical evaluation concerning the device can be displayed. These image information can be displayed, for instance, alternately with the usual data about the configuration of the device.

It is a particular advantage if a device error is displayed by the image information. For instance, also a change of the operating mode of the device may be defined as an error.

If the device is configured by a user, acknowledgments relating to the configuration can be displayed on the display area of the label.

Advantageously, a more intelligent user interface is thus provided without requiring any additional hardware expense.

In another advantageous embodiment of the subject matter of the invention input means are provided for acting on the control unit by a person. For instance, a touch screen or touch-sensitive screen may be provided. In this way an adequate user interface is provided on the object. The touch screen may be realized by an additional inventive label, or preferably by the display area of the provided one label, so as to realize a space-saving and cost-saving assembly. For instance, keys or the like may also be provided for a manual input, which form the user interface together with the label.

In addition, it is an advantage that multicolor display means are provided in the display area. For instance, commercially available, non-volatile displays can be written on via electric fields, specifically via the control unit.

Advantageously, protection means are provided for electrically protecting the display area. In industrial environments stronger electric fields and electric fields present in the short range may be present, which affect the displayed image information, especially interfere with them in a disadvantageous manner. The protection means can protect the displayed image information, for instance, in a Faraday cage type manner. A protection means is, for instance, a protective layer or metal coating, respectively.

It is further proposed to design the display area such that it can be rolled up and/or flipped open. Thus, a user of the device comprising the label can unroll or flip open the label so as to be able to read, for instance, all necessary image information and displayed image information, respectively.

Also, it is an advantage if an interface is provided for acting on the label and/or the control unit. For instance, different and in particular commercially available, e.g. wireless interfaces may be provided. This action may be accomplished, for instance, by a processing unit or processor, respectively, in particular a computer, a portable small computer or the like. Via one or more interfaces it is possible to change or otherwise influence the label and/or a software on the device, e.g. update, extend or replace it/them.

Thus, also software updates can be made, so that the label can be updated and adapted automatically.

Moreover, it is advantageous that image information can be written electronically into the display area by a write unit disposed outside of the device. Thus, the label can be written electronically, e.g. by means of external electric fields, in a flexible manner and without having to provide any other write device.

Moreover, it is an advantage that the control unit is adapted to acquire and process image information not provided by the control unit and visible in the display area. It is, for instance, conceivable that image information in the display area, which were written in, for instance, by external electric fields, are acquired and processed, specifically read out, by the control unit provided in the device. The so obtained image information can then be subjected to an update. An update may be waived if it is detected that the displayed image information provided by the external electric fields have not changed over the previously provided image information.

It is further proposed that control means, which are galvanically separated from the display area, are provided for writing image information into the display area of the label. It is frequently an advantage to seal the interior of the device tightly against the outside by housing means so as to prevent dust, water or the like from penetrating into the interior and keep electric interferences away from the interior. The display area is then written onto via wall sections of the housing means. Advantageously, for instance transmission means are provided to this end to allow image information to be written onto the display area through the housing means.

It is further proposed that a galvanic connection of the interior to the display area is optionally separable and connectable. Thus, for instance, electric lines between electric circuits located inside the device or enclosed by the housing means, respectively, can be galvanically connected to and galvanically separated from the display area.

Basically, the image information electronically read into the display area can be displayed in an optional form, e.g. as text and/or number code, but also in a bar code type manner. Bar codes allow the automatic identification of the device, e.g. by known bar code readers and bar code processing devices.

1. A device comprising a label for the device, wherein image information, in particular information about the device are provided in the label, wherein the label comprises a display unit with a display area, in which image information can be written electronically into the display area in a manner visible to a user, wherein the written image information remain on the display area even if the display unit is in a currentless state, and wherein the image information in the display area are electronically replaceable by other image information, and comprising a control unit for controlling the device, wherein the control unit is provided to electronically write in and/or replace image information in the display area, and wherein the control unit is adapted to display in the display area at least one status feature of the own mode of operation and/or an information reflecting this mode of operation.

2. The device according to claim 1, wherein the control unit is adapted, when the at least one status feature of the own mode of operation is changed, to update written image information with respect to the change made to the mode of operation and display them as currently valid image information.

3. The device according to claim 1 wherein the control unit is designed in such a way that, by an intended change of the image information to a currently valid image information, the mode of operation of the control unit is changed in accordance with the currently valid image information.

4. The device according to claim 1, wherein the label is provided on an outer side of the object.

5. The device according to claim 1, wherein the display unit is formed on housing means which surround the interior of the object.

6. The device according to claim 1, wherein the control unit is disposed inside a housing of the device.

7. The device according to claim 1, wherein the control unit is adapted to acquire the appropriate image information of the respective device and write them into the display area.

8. The device according to claim 1, wherein the control unit is adapted to update written image information about a variable characteristic feature of the control unit after a change of the characteristic features has taken place.

9. The device according to claim 1, wherein the control unit is adapted to write additional information provided in addition to information about the configuration of the control unit into the display area in an electronic manner.

10. The device according to claim 1, wherein input means are provided for acting on the control unit by a person.

11. The device according to claim 1, wherein multicolor display means are provided in the display area.

12. The device according to claim 1, wherein protection means are provided for electrically protecting the display area.

13. The device according to claim 1, wherein the display area is designed such that it can be rolled up and/or flipped open.

14. The device according to claim 1, wherein an interface is provided for acting on the label and/or the control unit.

15. The device according to claim 1, wherein image information can be written electronically into the display area by a write unit disposed outside of the device.

16. The device according to claim 1, wherein the control unit is adapted to acquire and process image information not provided by the control unit and visible in the display area.

17. The device according to claim 1, wherein control means galvanically separated from the display area are provided for writing image information into the display area of the label.

18. The device according to claim 1, wherein transmission means are provided to allow image information to be written onto the display area through the housing means.

19. The device according to claim 1, wherein a galvanic connection of the interior to the display area is separable and connectable.

20. The device according to claim 1 wherein the information displayed in the display area reflecting the mode of operation of the device includes how a user can use the device based on this mode of operation.
